(19) United States
(12) Patent Application Publication
(10) Pub. No.: US 2026/0033442 A1
(43) Pub. Date: Feb. 5, 2026

(54) Aerial Surveillance System and Method for Automated, Selective Landscaping Remediation Including Irrigation, Fertigation, and Crew Dispatch

(71) Applicant: Vincent Loccisano, Wellesley, MA (US)

(72) Inventor: Vincent Loccisano, Wellesley, MA (US)

(21) Appl. No.: 19/347,157

(22) Filed: Oct. 1, 2025

(51) Int. Cl. A01G 25/16; A01C 21/00; B64U 20/80; B64U 101/40; G06Q 50/02

(52) U.S. Cl. CPC A01G 25/16; A01C 21/005; B64U 20/80; G06Q 50/02; B64U 2101/40

(57) ABSTRACT

A data gathering module receives georeferenced data from a UAV over a target area. A processing module receives the captured georeferenced sensor data and analyzes the data to create detailed landscape condition maps using techniques such as machine learning and vegetation indices (NDVI, NDRE). In some embodiments the module automatically identifies and segments different landscape features such as turf, plants, weeds and hardscapes. The data processing module pinpoints specific problem areas or polygonal zones that require remediation for issues such as water stress, nutrient deficiency, weed infestation or pest damage and generates a specific remediation recommendation. An action module generates a set of targeted commands to accomplish the remediation recommendation, and a verification module compares the pre- and post-mediated areas to generate a verification report.

### TECHNICAL FIELD OF THE INVENTION

The present invention relates generally to landscaping assessment and remediation, specifically concerning systems and methods using low-altitude aerial sensing, analytics, and automated or crewed actuation to selectively water, fertilize, and otherwise remediate landscape zones based on the detected need.

### BACKGROUND OF THE INVENTION

Conventional landscape maintenance relies on scheduled or coarse-zone irrigation and periodic manual inspections, which can waste water and materials, may harm plant health with over- or under-treatment, and are labor intensive approaches. Systems are needed to provide frequent, high-resolution assessments of landscape condition to enable targeted, verifiable remediation actions, including automated control of irrigation and fertigation systems, aerial or ground applicators, and efficient crew dispatch.

Global Navigation Satellite System Real-Time Kinematic (GNSS RTK) is a high-precision positioning apparatus and method that uses a base station and a rover receiver to achieve centimeter-level accuracy by correcting common errors in satellite signals. The base station, located at a known position, transmits correction data to the rover allowing the rover to calculate its position with greater precision than standard GNSS systems. The technology is crucial for industries such as surveying, mapping and precision agriculture where highly accurate location data is essential. Post-Processing Kinematic (PPK) is a high-accuracy method that corrects location data of drone images after a flight rather than in real-time, by processing logged raw GNSS data from the drone and static base station.

Georeferencing is a process that associates spatial and attribute measurement data, enabling the data to be integrated and analyzed within Geographic Information Systems (GIS) with other geographic data.

A Normalized Difference Vegetation Indes (NDVI) is a remote sensing index that quantifies vegetation health by measuring the difference between the red and Near-Infrared (NIR) light deflected by plants. The NDVI is calculated using the formula (NIR-RED)/(NIR+RED) to generate a single value or image that indicates vegetation greenness, density and condition on a scale from −1 to 1. Higher NDVI values (0.06-. 09) indicate dense, healthy vegetation; while moderate values (0.02-. 05) indicate sparse or stressed plants. Negative numbers indicate environments such as bare soil.

Normalized Difference Red Edge (NDRE) is a vegetation index that measures chlorophyll content in plants. NDRE provides insights into plant health and maturity by analyzing red-edge and near-infrared light reflectance. The index is calculated by the formula (NIR-RedEdge)/(NIR+RedEdge_. The index is particularly useful for monitoring mature crops or detecting stress in dense canopies.

RGB, multispectral, and thermal cameras capture different parts of the electromagnetic spectrum to provide varying types of information. An RGB camera mimics human vision while multispectral and thermal cameras see light and energy that are invisible to the human eye.

### SUMMARY OF THE INVENTION

This invention pertains to a system and method for automated, high-precision landscaping and property maintenance. The invention uses unmanned aerial vehicles (UAVs) to systematically assess property conditions and to automatically execute targeted remedies. This leads to efficient use of resources such as water and fertilizer and to more effective problem resolution.

In an example embodiment an integrated system automates the cycle of landscape assessment, analysis, action and verification. Primary components include a data acquisition component, a data processing module, an action module and a verification module.

A UAV performing low-altitude flights over a target property captures high-resolution georeferenced sensor data including visual and multispectral imagery. Captured data provides a detailed picture of the target property's landscape health.

UAVs may be fixed-wing or multirotor configured for low-altitude missions, commonly 5-30 meters and preferably 8-20 meters over a target property. UAVs include GNSS/RTK or PPK for georeferencing and support payloads of RGB multispectral thermal cameras that include NIR/red-edge technology, thermal cameras and LiDAR and various environmental sensors such as soil moisture sensors. Georeferencing RTK/PPK GNSS is commonly mapped to +2-5 cm horizontal accuracy; lower-cost±20-50 cm allowed with zone margin adjustments.

UAVs are equipped with communications such as secure radio, 4G/5G, wi-Fi or local network links for data transfer and command/telemetry. Edge/Cloud Processing modules are used for image correction, radiometric calibration, stitching/orthomosaic generation, georectification, vegetation-index computation (NDVI, NDRE), thermal map processing, ML segmentation/anomaly detection, recommendation engine, data storage, APIs, and logging. Vegetation indices and threshold examples include NDVI=(NIR-Red)/(NIR+Red). An NDVI 0.55: indicates healthy vegetation. An NDVI measurement between 0.35≤NDVI <0.55: indicates moderate stress which may lead to a recommendation to monitor or introduce light irrigation and/or fertilizer. An NDVI <0.35: indicates high stress and may lead to a recommendation for remediation. An NDRE threshold example wherein NDRE <0.20 may be analyzed as a possible nutrient deficiency and may lead to a recommendation for irrigation and fertilizer.

An irrigation runtime calculation example is demonstrated by the following formula: Required_volume_L=zone_area_m2 x root_zone_depth_m×target_delta_VWC×soil_bulk_factor. While a runtime minimum is calculated by the following: Runtime_min=Required_volume_L/zone_nominal_flow_rate_L_per_min. With a minimum interval between automated irrigations per zone is 12-24 hours. A pulse irrigation option example is defined as 3×10 min cycles with soak intervals.

Fertilizer and weed control parameters are governed by the following. Granular fertilizer rates in one example are: ˜0.5-2.0 kg/ha (corrective application examples 0.5-1.0 kg/ha). Liquid fertigation: 0.1-0.5 L/m2 diluted solution, depending on the specific nature of the product. An example weed actionable fraction may be defined as: weed_coverage_fraction>0.05 (5% of zone) and confidence ≥0.85. Re-treatment intervals may be defined by the following: herbicide 3-21 days per product label; fertilizer responses assessed 7-21 days post-application. One skilled in the art understands that drone payload and flight time limit per-mission may be split into separate missions as required by drone physical limits. Weather my also play a role in applicator constraints may also be governed by weather, for example a drone is unlikely to spray if wind >4-6 m/s, and may require buffer zones near sensitive targets.

In some embodiments Ground Sample Distance (GSD) is between 2-10 cm/pixel. For example a 12 megapixel camera at 12m Above Ground Level (AGL) would provide approximately 3 cm/pixel. One skilled in the art understands that frontlap is commonly 70-85% and sidelap is commonly 60-75% for appropriate image stitching.

Thermal thresholds include a thermal delta threshold defined by the equation zone_surface_temp-local_baseline_temp >3-5° C.→possible irrigation failure/heat stress.

Confidence and area gating thresholds include per-patch confidence threshold for automated action: >0.8 with a minimum contiguous actionable area between 0.5-1.0 m\hat{ }2; automated actuation recommended only for contiguous stressed area ≥1.0 m\hat{ }.

A data processing module receives the captured georeferenced sensor data and analyzes the data to create detailed landscape condition maps using techniques such as machine learning and vegetation indices (NDVI, NDRE). In some embodiments the module automatically identifies and segments different landscape features such as turf, plants, weeds and hardscapes. The data processing module pinpoints specific problem areas or polygonal zones that require remediation for issues such as water stress, nutrient deficiency, weed infestation or pest damage. For each zone, the module generates a specific remediation recommendation.

An analytics/ML engine is employed for segmentation models defining turf, plants, hardscape, weeds and the like. Anomaly detectors mark water stress, nutrient deficiency, pest damage and the like. Submodules determine confidence scoring and parameter estimation.

Zone definition and targeting zones are polygonal zones defined in property coordinates. One skilled in the art is familiar with polygonal zones as defined by GeoJSON or WGS84, for example. Each zone stores metadata including zone_id, associated controller_id, valve_id, nominal_flow_rate (L/min), nominal_run_time (min), soil_type, plant_type, last_irrigation_time, and access notes.

An analytics and recommendation engine as part of the data processing module computes landscape condition maps using NDVI and NDRE thermal maps and applies ML segmentation and anomaly detection to classify turf, plants, hardscape, and weeds and to identify patches of stress or infestation with per-pixel/patch confidence. The recommendation engine forms polygonal candidate zones from contiguous anomalous pixels that meet area and confidence gating and computes per-zone statistics (mean indices, thermal delta, confidence) to select remediation actions and parameters.

An action module translates remediation recommendations into direct commands. In an example embodiment the action module issues targeted irrigation commands to a smart irrigation controller, calculating the precise runtime needed for a specific zone based on its area, soil conditions and moisture deficit. The action module may also transmit variable-rate fertigation commands to a fertigation system, delivering precise doses of nutrients only where needed. The action module may further dispatch an automated applicator such as a spraying drone or ground robot with a detailed mission plan including waypoints and application rates, to treat issues such as weed infestations. The action module may further generate detailed crew-dispatch instructions for manual tasks providing a work order with georeferenced locations, task descriptions and lists of required equipment and materials. This action may be used for lawn mowing, plant replacement, vegetation pruning and the like.

The action module includes adapters to irrigation/fertigation controllers, automated applicators such as robotic ground vehicles, spray drones, and third-party crew-dispatch APIs; includes safety and policy gating such as geofence/privacy.

The action module uses georeferenced landscape-condition maps to determine irrigation needs per polygonal zone and issues targeted irrigation commands to controllers or schedules crew tasks. Decision metrics and threshold examples include NDVI thresholds, thermal delta, confidence gating, minimum contiguous area, minimum interval between irrigations. Some example action types include zone-level runtime increases, scheduled targeted irrigation, variable-rate application (where supported), and pulse irrigation cycles. a calculation example may include computing required volume from a zone area, root zone depth and target volumetric water content delta and then converting to runtime using nominal flow rate while clamping runtime to permitted bounds. One skilled in the art understands that scheduling may favor nocturnal or early morning windows that are respectful of municipal watering restrictions and customer preferences. Furthermore actuation may be halted if municipal restrictions prohibit or if a geofence indicates a public overlap or if regulatory constraints require approval.

Selective fertilization and weed-control are directed through the action module through automated or manual directions. The action module uses indices (NDRE, NDVI), segmentation (including weed masks), time-series change detection, and ML models to detect nutrient deficiencies and weed infestations and to issue targeted remediation. The action module uses detection metrics including NDRE thresholds for nutrient deficiency while NDVI vs NDRE divergence is used to distinguish nutrient stress from water stress and weed coverage fraction and per-patch confidence. Example actions may include crew-applied granular or liquid fertilizer and manual weed removal, or automated application by robotic ground vehicles or aerial sprayers/drones; or variable rate fertigation via existing irrigation controllers. Example application parameters include product-specific rates, concentration, payload limitations, spray/nozzle settings, wind and weather gating, buffer zones and no-spray zones. Mission planning for automated applications may include computing sorties given payload limits, generating mission plans with waypoints, per-waypoint application settings, recognizing safety constraints and implementing in-flight fail-saves. Crew tasks may include generating crew-dispatch tasks including product SKU, per area rate, spreader or sprayer settings PPE, estimated material quantity, expected duration and adhering to safety instructions. Adhering to scheduling and regulatory compliance may include respecting label instructions, following local pesticide regulations, customer preferences and avoiding forecasted precipitation windows and recognizing wind limits.

A user interface includes web and mobile dashboards for map visualization review and approval; scheduling and task management. In some embodiments on-site guidance, proof of work and billing for dispatched crews is monitored by a mobile application. Dispatching and scheduling includes integrating with third party dispatch platforms to optimize routing, assign crews based on skills and equipment or availability and providing ETA updates and notifications. The crew mobile app may feature a map with zone polygon and GPS guidance, step checklists, geotagged photos, material logging, actual time tracking and optional notes. The crew mobile app features proof of work checklists accepting crew-uploaded evidence and the like. The crew mobile app further includes a billing and inventory module that generates billing line items from actual labor and materials reconciling inventory accurately.

In some embodiments, the system ensures efficacy through a verification module that schedules a follow-up UAV survey after a remediation action. By comparing pre and post-treatment maps, the verification module calculates a success metric and uses this feedback to update and improve the analytical models. The system also incorporates practical features such as privacy gating to mask sensitive information in imagery and logic to block actions that would violate municipal restrictions such as watering or pesticide bans. In an example embodiment a post-irrigation verification flight is scheduled or soil moisture sensors may be read to compute improvement metrics and to adjust models.

In an example embodiment a verification metric may define irrigation success by the following formula: delta_NDVI=NDVI_post-NDVI pre; success threshold e.g., +0.10 within 48-72 hours. Further the verification metric may define fertilization success by the following formula: delta_NDRE ≥+0.08 within 7-21 days. Weed removal success may be defined by the following: weed_area_reduction %≥75% within 3-14 days.

In other embodiments of the system safety, privacy and regulatory gating is provided, for example, through geofence enforcement and privacy masking of faces and license plates in captured imagery. In another example, blocking of human-in-the-loop gating is used when municipal watering or pesticide restrictions apply or when chemicals are proposed without customer opt-in, or when staff certification is required.

In an additional embodiment a method comprises defining a geographic area of service and obtaining subscriptions for landscaping services from a plurality of properties within the defined area. Each subscribed property is assessed to determine specific landscaping requirements, which may include needs related to watering, fertilization, and pest mitigation. Based on the assessment, internal resources, including equipment and inventory, are allocated and subsequently deployed to the property to perform tasks that fulfill the determined requirements. Upon confirmation that the tasks are completed, the process may be repeated to provide ongoing service.

### BRIEF DESCRIPTION OF DRAWINGS

FIG. 1 is a perspective view of an example embodiment in a field;

FIG. 2A is a diagram of a method of the apparatus;

FIG. 3 is a plan view of a polygonal map.

FIG. 4 is a diagram of a method of the embodiment.

### DETAILED DESCRIPTION OF THE INVENTION

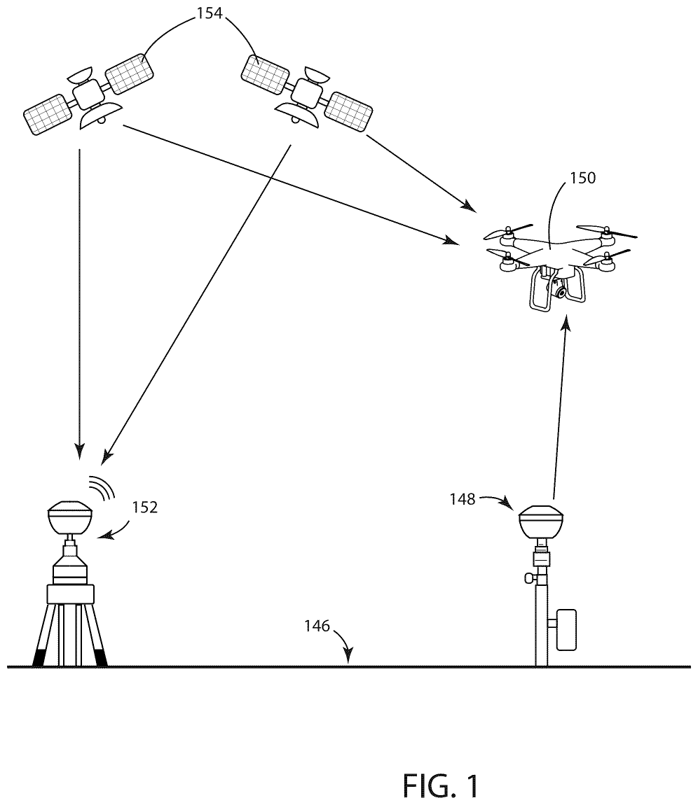

In FIG. 1 a base station 152 is mounted on the ground 146. GNSS satellites 154 send signals to the base station 152 and to a UAV 150. A control unit 148 sends signals to the UAV 150. The UAV is configured to fly at low altitude, sensing, per property geospatial zone definitions, analytics including vegetation indices and ML segmentation/anomaly detection; rule-based and model-based recommendation engines; automated and crewed action modules; and verification/learning loops to deliver targeted landscape remediation. Remediation may include irrigation, fertigation, fertilization, weed-control, trimming, mowing, plant replacement, debris removal and irrigation inspection.

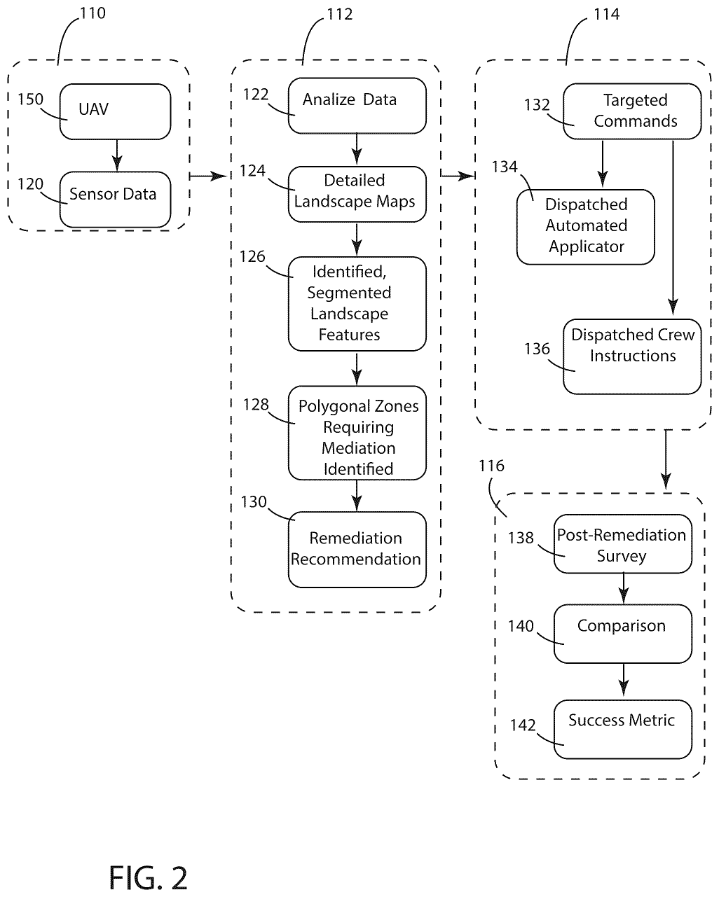

FIG. 2 is a diagram depicting a method of use of the system of FIG. 1. An integrated system automates the cycle of landscape assessment by data acquisition 110, analysis through a data processing module 112, action through an action module 114 and verification through a verification module 116.

A UAV 150 performing low-altitude flights over a target land mass captures high-resolution georeferenced sensor data 120. The sensor data 120 is sent to the data processing module 112 that receives and analyzes the data 122. Detailed landscape maps 124 are generated form the analyzed data 122. Landscape features are identified and segmented 126. A polygonal map is generated from the segmented features and polygonal zones requiring mediation are identified 128. A remediation recommendation 130 is then generated.

The action module 114 proceeds with targeted commands 132 that may be dispatched through an automated applicator 134 such as a robotic ground vehicles or spray drones; or may be delivered to a crew of individuals 136 to deliver targeted commands.

The verification module 116 provides a post-remediation survey 138 wherein a comparison 140 is made between the pre-remediation status and the post-remediation status of the polygonal segments mediated. A success metric 142 is generated from the comparison 140.

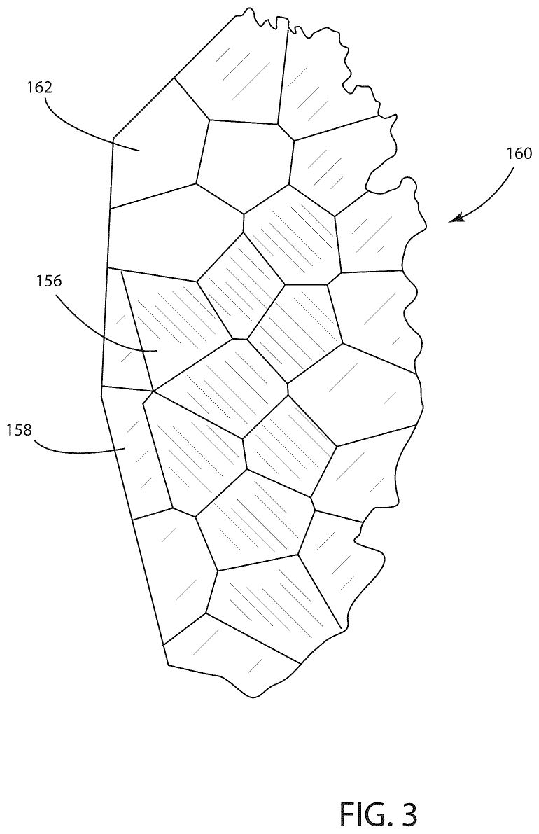

FIG. 3 depicts an example polygonal map of a target landscape area. Polygons with multiple shading marks 156 denote dense vegetation areas while polygons with fewer shading marks 158 denote lighter vegetation and polygons with no shading marks 162 denote paved, gravel or bare earth regions.

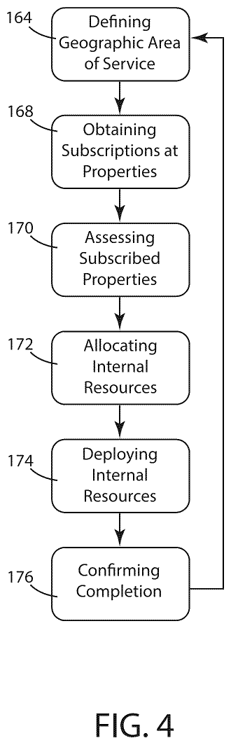

FIG. 4 is a diagram depicting the steps of a method of the embodiment. The method includes the steps of defining a geographic area of service 164 and obtaining subscriptions at a number of properties 168 within the defined geographic area of service. The method continues by assessing subscribed properties 170 for their landscaping needs. Landscaping needs may include watering needs in general and specific needs in specific polygonal areas, fertilizer needs, pest and weed mitigation needs as well as safety, privacy and regulatory requirements. The method continues by allocating internal resources 172, which may include checking internal inventory and equipment and readying deployment of the inventory and equipment. The method follows by deploying the internal resources 174 to the specific property to accomplish the tasks required by the assessment for that specific property. In a final step, the method includes confirming completion 176 of the tasks required by the assessment and finally repeating the process.

1. A landscaping assessment and action system comprising:
an unmanned aerial vehicle configured to perform one or more low-altitude flights over a target property and to capture georeferenced sensor data of the target property; and
a data processing module in communication with the UAV, the data processing module configured to: receive the georeferenced sensor data, analyze at least one landscape-condition map indicating one or more polygonal zones requiring remediation based on the received sensor data, and generate one or more remediation recommendations for the one or more polygonal zones; and
an action module configured to cause execution of at least one remediation action targeted to the one or more polygonal zones, the remediation action selected from issuing a targeted irrigation command to an irrigation controller, and issuing a targeted fertigation command to a fertigation system, commanding an automated applicator to apply a product to one or more polygonal zones, and generating a crew-dispatch instruction for manual remediation.

2. The system of claim 1 further comprising a verification module configured to:
receive post-remediation georeferenced sensor data of the target property; and
compare the post-remediation georeferenced sensor data of the target property; and
generate a success metric based on the comparison.

3. The system of claim 1 wherein:
the action module computes a per-zone irrigation runtime by computing required_volume_L=zone_area_m2×root-zone-depth_m×target-delta_VWC×soil_bulk_factor, computing runtime_min=
required_volume_L/zone_nominal_flow_rate_L_per_min, and transmitting a command to an irrigation controller comprising a zone identifier and the computed runtime_min.

4. The system of claim 1 wherein:
the data processing module applies a machine learning model to segment turf, plants, hardscape, and weeds, to detect weed coverage fraction in a zone, and to output per-patch confidence scores, and wherein the action module generates a spot-spray mission when weed coverage fraction >0.05 and model confidence≥0.85.

5. The system of claim 1 wherein:
the data processing module computes one or more vegetation indices including normalized difference vegetation index (NDVI) or normalized difference red edge (NDRE) and uses the indices to detect water stress or nutrient deficiency.

6. The system of claim 1 wherein:
the action module generates a crew-dispatch instruction comprising a task identifier, property identifier, georeferenced polygon, primary waypoint, task type selected from the group consisting of trim_bushes, mow_lawn, replace_plant, remove_debris, and inspect_irrigation, an estimated duration, a required equipment list, and a materials list.

7. The system of claim 1 wherein:
the action module generates a mission plan for an automated applicator, the mission plan comprising one or more waypoints, per-waypoint application rates, vehicle altitude, nozzle settings, and safety constraints, and transmits the mission plan to the automated applicator.

8. The system of claim 1 further comprising:
privacy gating that masks faces and license plates in captured imagery and blocks automatic actuation if municipal watering or pesticide restrictions prohibit the remediation action.

9. A method for targeting landscaping remediation, the method comprising:
flying, by an unmanned aerial vehicle, a low-altitude mission over a target property to capture georeferenced sensor data; and
transmitting the georeferenced sensor data to a data processing module; and
processing, by the data processing module, the georeferenced sensor data to generate a landscape-condition map that identifies one or more polygonal zones exhibiting at least one condition selected from water stress, nutrient deficiency, pest damage, weed infestation, and dead vegetation; and
generating, by the data processing module, one or more remediation recommendations targeted to the one or more polygonal zones; and
issuing, by an action module, one or more targeted control commands to at least one of an irrigation controller, a fertigation system, an automated applicator, or a crew-dispatch system to apply the remediation recommendations to the one or more polygonal zones.

10. The method of claim 9 wherein:
generating remediation recommendations comprises:
computing one or more vegetation indices including NDVI and NDRE, applying a machine learning segmentation model to classify pixels into turf, plant, hardscape, and weed classes, and forming polygonal zones for remediation by polygonizing contiguous pixels that meet index and confidence thresholds.

11. The method of claim 9 further comprising:
scheduling and performing a verification action after remediation and computing a remediation success metric defined as success %=(area_improved/area_treated)×100.

12. The method of claim 9 wherein:
the low-altitude mission is flown at an altitude between 5 m and 30 m.

13. The method of claim 11 wherein:
the verification action includes flying over the affected area after remediation and gathering images with a ground sample distance that is between 2-10 cm/pixel.

14. A non-transitory computer-readable medium storing instructions that, when executed by one or more processors, cause the processors to perform steps comprising:
receiving georeferenced sensor data captured by an unmanned aerial vehicle during a low-altitude survey of a target property; generating a landscape-condition map that identifies one or more polygonal zones requiring remediation; and
generating: remediation recommendations for the identified polygonal zones; and
transmitting one or more targeted control commands to at least one of an irrigation controller, a fertigation system, an automated applicator, or a crew-dispatch platform to apply the remediation recommendations to the identified polygonal zones.

15. The computer-readable medium of claim 14 wherein:
the instructions further cause the processors to compute required fertilizer mass for a zone using required_mass_kg=target_rate_kg_per_ha×zone_area_m2/10000 and to convert the required_mass_kg to a fertigation volume using product concentration before transmitting a variable-rate fertigation command.

16. The method of claim 14 wherein:
the low-altitude survey is flown at an altitude between 5 m and 30 m and preferably between 8 m and 20 m.
